(19) United States
(12) Patent Application Publication
(10) Pub. No.: US 2021/0079866 A1
(43) Pub. Date: Mar. 18, 2021

(54) CLICK HEATMAP ABNORMALITY DETECTION METHOD AND APPARATUS

(71) Applicant: BEIJING GRIDSUM TECHNOLOGY CO., LTD., Beijing (CN)

(72) Inventor: Zhenhua LIU, Beijing (CN)

(73) Assignee: BEIJING GRIDSUM TECHNOLOGY CO., LTD., Beijing (CN)

(21) Appl. No.: 16/642,276

(22) PCT Filed: Sep. 28, 2018
(86) PCT No.: PCT/CN2018/108160

§ 371 Date: Feb. 26, 2020

(30) Foreign Application Priority Data
Sep. 29, 2017 (CN) 201710904819.4

(51) Int. Cl. F02D 41/22; G09B 29/00

(52) U.S. Cl. CPC F02D 41/222; G09B 29/007; F02D 41/221

(57) ABSTRACT

A method and a device for detecting an abnormality in a click heatmap are provided. In the method, a to-be-detected region in a first click heatmap is determined. Click source data of the to-be-detected region is compared with click source data of a normal click region, to obtain a first comparison result. Whether the to-be-detected region is an abnormal click region is determined based on the first comparison result.

The present application claims priority to Chinese Patent Application No. 201710904819.4, titled “CLICK HEATMAP ABNORMALITY DETECTION METHOD AND APPARATUS”, filed on Sep. 29, 2017 with the Chinese Patent Office, which is incorporated herein by reference in its entirety.

### FIELD

The present disclosure relates to the field of detection of cheating on Internet traffic, and in particular to a method and a device for detecting an abnormality in a click heatmap.

### BACKGROUND

With the development of Internet, more and more users browse webpages and application interfaces via electronic devices. By buying an advertisement, more Internet traffic may be brought to an advertisement buyer, such that more users browse and click webpages of a website or application interfaces of the advertisement buyer. However, legitimate interests of the advertisement buyer are damaged by traffic cheating behaviors for a long time. For example, some software for creating fake traffic may automatically and frequently access the website of the advertisement buyer and perform a large amount of clicks on the website of the advertisement buyer. These clicks bring no earnings to the advertisement buyer, while the advertisement buyer has to pay for them.

A click heatmap can well represent clicks on a webpage of a website or an application interface. Therefore, abnormal click behaviors can be determined based on the click heatmap, so that abnormal traffics can be recognized. In the conventional technology, the abnormal click behaviors represented in the click heatmap are recognized manually, resulting in low accuracy and low recognition efficiency.

### SUMMARY

In view of the above, a method and a device for detecting an abnormality in a click heatmap are provided in the present disclosure, so as to overcome or at least partly solve the above problems. Technical solutions are described as follows.

A method for detecting an abnormality in a click heatmap is provided. The method includes: acquiring a first click heatmap, and determining a to-be-detected region in the first click heatmap; comparing click source data of the to-be-detected region with click source data of a normal click region, to obtain a first comparison result; and determining whether the to-be-detected region is an abnormal click region based on the first comparison result.

Optionally, the determining a to-be-detected region in the first click heatmap includes: dividing the first click heatmap into multiple sub-regions having a same area and a same shape; and segmenting the first click heatmap which is divided into the multiple sub-regions by using an image segmentation algorithm, to obtain a to-be-detected region formed by several of the multiple sub-regions, where a click amount of each of the several of the multiple sub-regions in the to-be-detected region is greater than a first preset threshold. The method further includes: determining a region other than the to-be-detected region in the first click heatmap as the normal click region.

Optionally, the method further includes: acquiring a second click heatmap, and determining a to-be-detected region in the second click heatmap, where the first click heatmap is obtained for a first page in a first time period, the second click heatmap is obtained for the first page in a second time period, and the first time period is different from the second time period; comparing the click source data of the to-be-detected region in the second click heatmap with the click source data of the to-be-detected region that is not determined as an abnormal click region in the first click heatmap, to obtain a second comparison result; and determining whether the to-be-detected region in the second click heatmap is an abnormal click region based on the second comparison result.

Optionally, the comparing the click source data of the to-be-detected region with he click source data of a normal click region, to obtain a first comparison result includes: calculating a correlation coefficient between the click source data of the to-be-detected region and the click source data of the normal click region, where the calculated correlation coefficient serves as the first comparison result.

Optionally, the determining whether the to-be-detected region is an abnormal click region based on the first comparison result includes: determining whether the correlation coefficient serving as the first comparison result is less than a second preset threshold, and determining that the to-be-detected region is an abnormal click region in a case that the correlation coefficient serving as the first comparison result is less than the second preset threshold.

Optionally, the method further includes: adding a predetermined mark to the to-be-detected region that is determined as the abnormal click region.

A device for detecting an abnormality in a click heatmap is provided. The device includes a to-be-detected region determining unit, a first comparing unit, and an abnormality determining unit. The to-be-detected region determining unit is configured to acquire a first click heatmap and determine a to-be-detected region in the first click heatmap. The first comparing unit is configured to compare click source data of the to-be-detected region with click source data of a normal click region, to obtain a first comparison result. The abnormality determining unit is configured to determine whether the to-be-detected region is an abnormal click region based on the first comparison result.

Optionally, the to-be-detected region determining unit includes a dividing subunit and a segmenting subunit. The dividing subunit is configured to divide the first click heatmap into multiple sub-regions having a same area and a same shape. The segmenting subunit is configured to segment the first click heatmap which is divided into the multiple sub-regions by using an image segmentation algorithm, to obtain a to-be-detected region formed by several of the multiple sub-regions, where a click amount of each of the several of the multiple sub-regions in the to-be-detected region is greater than a first preset threshold. The device further includes a normal click region determining unit, which is configured to determine a region other than the to-be-detected region in the first click heatmap as the normal click region.

A storage medium is provided, which includes programs. The programs, when being executed, control a device in which the storage medium is located to perform the above-mentioned method for detecting an abnormality in a click heatmap.

A processor is provided, which is configured to execute programs to perform the above-mentioned method for detecting an abnormality in a click heatmap.

In the above technical solutions, with the method and the device for detecting an abnormality in a click heatmap provided in the present disclosure, the to-be-detected region in the first click heatmap is determined. The click source data of the to-be-detected region is compared with the click source data of the normal click region, to obtain the first comparison result. Whether the to-be-detected region is an abnormal click region is determined based on the first comparison result. It is found from studies that, click source data of an abnormal click region is significantly different from the click source data of the normal click region. Therefore, whether the to-be-detected region is an abnormal click region can be determined based on a comparison result between the click source data of the to-be-detected region and the click source data of the normal click region, such that the abnormal click region is automatically recognized, thereby improving accuracy and recognition efficiency.

The above description is merely a summary of the technical solutions of the present disclosure. For a clearer understanding of the technical means of the present disclosure to implement the technical solution in the present disclosure, and to make the above and other objects, features and advantages of the present disclosure clear and easily understood, specific embodiments are described in detail below.

### BRIEF DESCRIPTION OF THE DRAWINGS

In order to more clearly illustrate technical solutions in embodiments of the present disclosure or in the conventional technology, the drawings to be used in the description of the embodiments or the conventional technology are briefly described below. Apparently, the drawings in the following description show only some embodiments of the present disclosure, and other drawings may be obtained by those skilled in the art from the drawings without any creative work.

FIG. 1 is a schematic flowchart of a method for detecting an abnormality in a click heatmap according to an embodiment of the present disclosure;

FIG. 2 is a schematic diagram of click data according to an embodiment of the present disclosure;

FIG. 3 is a schematic diagram of a click heatmap according to an embodiment of the present disclosure;

FIG. 4 is a schematic diagram of to-be-detected regions according to an embodiment of the present disclosure;

FIG. 5 is a schematic diagram of normal click regions according to an embodiment of the present disclosure;

FIG. 6 is a schematic diagram showing correlation coefficients between click source proportions of to-be-detected regions and click source proportions of a normal click region according to an embodiment of the present disclosure;

FIG. 7 is a schematic diagram showing that a heatmap covers an interface according to an embodiment of the present disclosure;

FIG. 8 is a schematic flowchart of a method for detecting an abnormality in a click heatmap according to another embodiment of the present disclosure; and

FIG. 9 is a schematic structural diagram of a device for detecting an abnormality in a click heatmap according to an embodiment of the present disclosure.

### DETAILED DESCRIPTION OF EMBODIMENTS

The technical solutions in the embodiments of the present disclosure are described clearly and completely in conjunction with the drawings in the embodiments of the present disclosure hereinafter. It is apparent that the described embodiments are only some embodiments of the present disclosure, rather than all embodiments. All other embodiments obtained by those skilled in the art based on the embodiments of the present disclosure without any creative work fall within the protection scope of the present disclosure.

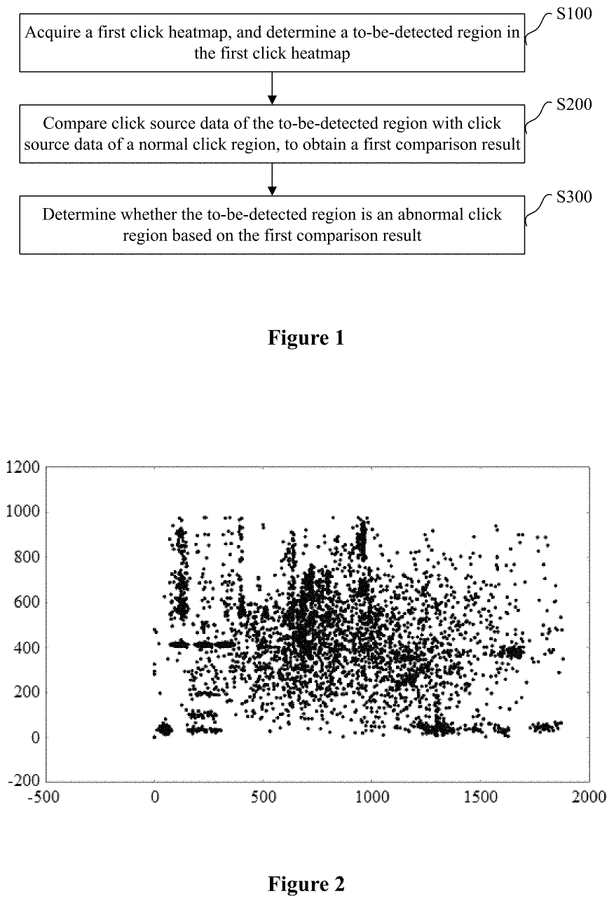

As shown in FIG. 1, a method for detecting an abnormality in a click heatmap provided according to an embodiment of the present disclosure may include the following steps S100 to S300.

In step S100, a first click heatmap is acquired, and a to-be-detected region in the first click heatmap is determined.

In the present disclosure, the first click heatmap may be acquired from other electronic devices. Alternatively, the first click heatmap may be generated based on click data from other electronic devices.

In the present disclosure, the click data may be normalized after being acquired, and then is transposed, divided into intervals, and filtered. Finally, a click heatmap is generated based on the filtered click data.

The to-be-detected region in the first click heatmap may be a region having a larger click amount than other regions in the first click heatmap.

Optionally, the to-be-detected region in the first click heatmap may be determined by performing the steps of: dividing the first click heatmap into multiple sub-regions having a same area and a same shape, and segmenting the first click heatmap which is divided into the multiple sub-regions by using an image segmentation algorithm, to obtain a to-be-detected region formed by several of the multiple sub-regions, where a click amount of each of the several of the multiple sub-regions in the to-be-detected region is greater than a first preset threshold.

Based on this, the method as shown in FIG. 1 further includes: determining a region other than the to-be-detected region in the first click heatmap as a normal click region.

Each of the multiple sub-regions may be formed by one or more pixels.

The image segmentation algorithm used in the present disclosure may be a threshold-based segmentation algorithm, a region-based segmentation algorithm, a margin-based segmentation algorithm or the like. A process of image segmentation is described below with an example of threshold-based segmentation algorithm. Firstly, a first preset threshold is determined based on click amounts of the multiple sub-regions in the first click heatmap (for example, the first preset threshold may be an average of the click amounts of the multiple sub-regions). Then, the click amounts of the multiple sub-regions are each compared with the first preset threshold, to determine some sub-regions having click amounts greater than the first preset threshold. A sub-region is selected from the sub-regions having click amounts greater than the first preset threshold, to serve as a current region. If another sub-region having a click amount greater than the first preset threshold is fusible with the current region to form an integrated region, the sub-region is fused with the current region. If there are still one or more of the sub-regions having click amounts greater than the first preset threshold which are not fused, one of the sub-regions which are not fused is selected, to serve as the current region, and the method returns to the step that if another sub-region having a click amount greater than the first preset threshold is fusible with the current region to form an integrated region, the sub-region is fused with the current region.

It is founded by the present disclosure that, click data generated from fake traffic is generally concentrated in some regions, resulting in large click amounts of these regions. Therefore, in the present disclosure, a region having a large click amount may be determined as the to-be-detected region. Accordingly, a region having a small click amount may be determined as a normal click region. It is also found that distributions of sources of click data of two different regions are similar to each other if the click data is generated by real users. For example, a webpage includes a first region and a second regain, and click data of the webpage comes from three sources B, C and D. Proportions of the click data from the three sources to total click data of the first region are 10%, 20% and 70%, respectively. Proportions of the click data from the three sources to total click data of the second region are 8%, 23% and 69%, respectively.

In step S200, click source data of the to-be-detected region is compared with click source data of a normal click region, to obtain a first comparison result.

Optionally, the comparison between the click source data in step S200 may include: calculating a correlation coefficient between the click source data of the to-be-detected region and the click source data of the normal click region, where the calculated correlation coefficient serves as the first comparison result.

In the step S200, the comparison between the click source data may also be performed by calculating a covariance or the like, which is not limited herein.

In step S300, whether the to-be-detected region is an abnormal click region is determined based on the first comparison result.

The step S300 may include: determining whether the correlation coefficient serving as the first comparison result is less than a second preset threshold, and determining that the to-be-detected region is an abnormal click region in a case that the correlation coefficient serving as the first comparison result is less than the second preset threshold.

Optionally, in the present disclosure, in a case that the correlation coefficient serving as the first comparison result is not less than the second preset threshold, the to-be-detected region may be determined as a normal click region.

Optionally, the method shown in FIG. 1 further includes: adding a predetermined mark to the to-be-detected region that is determined as the abnormal click region.

By adding the predetermined mark, it is convenient for an advertisement buyer to find the abnormal click region determined according to the present disclosure.

Further, the first click heatmap in which the abnormal click region is added with the predetermined mark may cover an interface image corresponding to the first click heatmap. The interface image may be a webpage interface image, an application interface image, or the like. By covering the interface image, it is further convenient for a user to find a position of the abnormal click region in the interface image, for further analysis and use.

For better understanding, an example is described as follows.

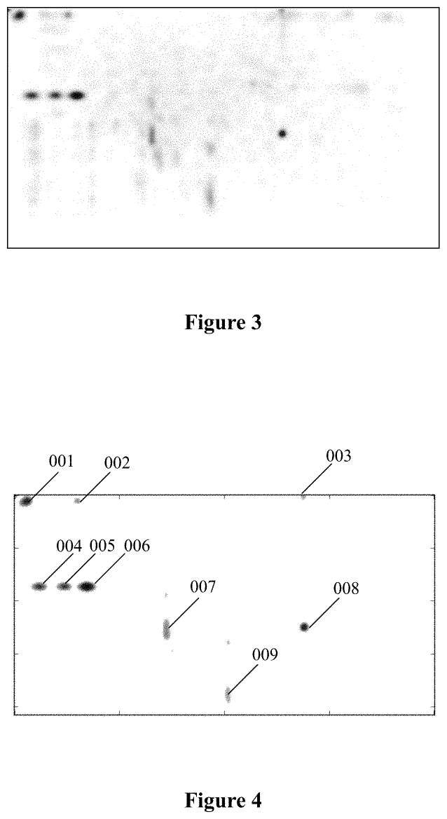

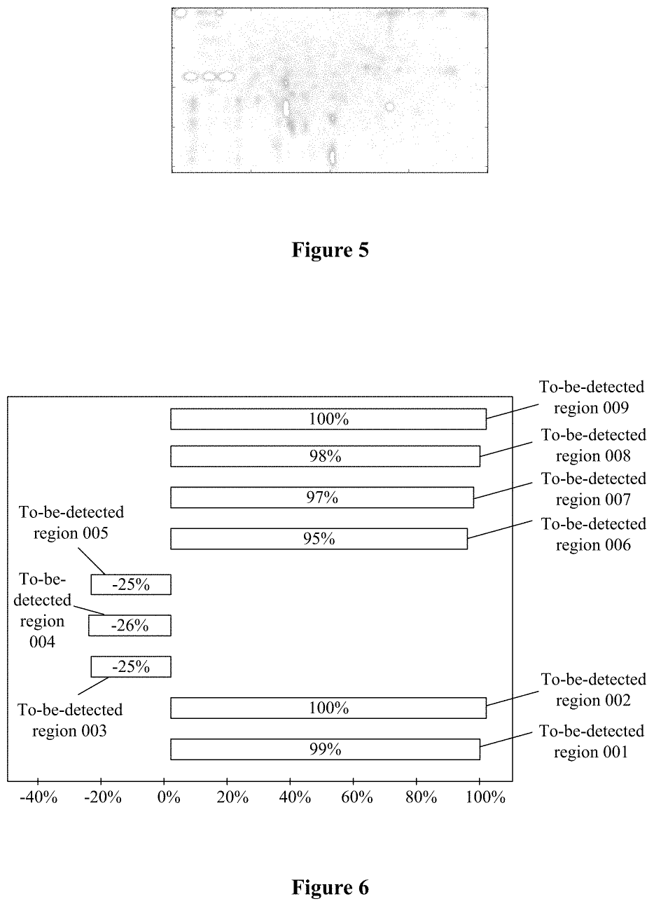

It is assumed that the normalized click data is shown in FIG. 2. After the click data shown in FIG. 2 is transposed, divided into intervals, and filtered, a click heatmap as shown in FIG. 3 may be generated based on the filtered click data. Nine to-be-detected regions 001 to 009 as shown in FIG. 4 and a normal click region as shown in FIG. 5 are obtained by using the image segmentation algorithm. Click source proportions of the to-be-detected regions and click source proportions of the normal click region are shown in Table 1.

TABLE 1
click source proportions of to-be-detected regions and
click source proportions of a normal click region

| | Source | | | | | |
|---|---|---|---|---|---|---|
| | Click | Click | Click | Click | Click | Click |
| Region | source a | source b | source c | source d | source e | source f |
| To-be-detected | 19.33% | 77.31% | 2.94% | 0.00% | 0.00% | 0.42% |
| region 001 | | | | | | |
| To-be-detected | 8.62% | 91.38% | 0.00% | 0.00% | 0.00% | 0.00% |
| region 002 | | | | | | |
| To-be-detected | 1.25% | 0.25% | 0.00% | 0.00% | 0.00% | 98.51% |
| region 003 | | | | | | |
| To-be-detected | 0.98% | 0.00% | 0.00% | 0.00% | 0.00% | 99.02% |
| region 004 | | | | | | |
| To-be-detected | 1.03% | 0.51% | 0.51% | 0.00% | 0.00% | 97.94% |
| region 005 | | | | | | |
| To-be-detected | 0.00% | 72.73% | 18.18% | 0.00% | 0.00% | 9.09% |
| region 006 | | | | | | |
| To-be-detected | 24.58% | 58.10% | 9.50% | 1.12% | 5.59% | 1.12% |
| region 007 | | | | | | |
| To-be-detected | 0.00% | 90.91% | 9.09% | 0.00% | 0.00% | 0.00% |
| region 008 | | | | | | |
| To-be-detected | 17.20% | 69.89% | 7.53% | 0.00% | 3.23% | 2.15% |
| region 009 | | | | | | |
| Normal click | 13.28% | 77.75% | 5.76% | 1.34% | 1.01% | 0.87% |
| region | | | | | | |

A correlation coefficient between click source proportions of each of the to-be-detected regions and click source proportions of the normal click region is calculated. The correlation coefficients are shown in FIG. 6.

It can be seen from the correlation coefficients shown in FIG. 6, each of the to-be-detected region 3, the to-be-detected region 4 and the to-be-detected region 5 corresponds to a small correlation coefficient, so that the three to-be-detected regions are determined as abnormal click regions. However, each of the other six to-be-detected regions corresponds to a large correlation coefficient, so that each of the other six to-be-detected regions is determined as not an abnormal click region.

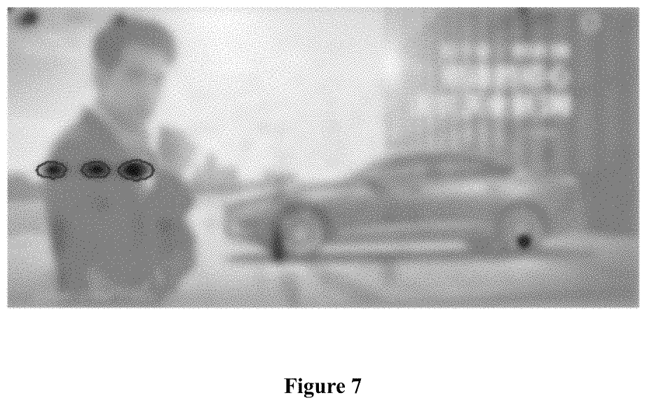

As shown in FIG. 7, the determined abnormal click regions (namely, the to-be-detected region 3, the to-be-detected region 4 and the to-be-detected region 5) are circled to be marked. Further, the click heatmap covers the interface (which is blurred in the present disclosure) corresponding to the click heatmap.

Optionally, in the present disclosure, click source data of the to-be-detected region which is not determined as the abnormal click region in the step S300 may be used to compare with click source data of a to-be-detected region in another click heatmap.

In the method for detecting an abnormality in a click heatmap according to the embodiment of the present disclosure, the to-be-detected region in the first click heatmap is determined. The click source data of the to-be-detected region is compared with the click source data of the normal click region, to obtain the first comparison result. Whether the to-be-detected region is an abnormal click region is determined based on the first comparison result. It is found from studies that click source data of an abnormal click region is significantly different from the click source data of the normal click region. Therefore, whether the to-be-detected region is an abnormal click region can be determined based on a comparison result between the click source data of the to-be-detected region and the click source data of the normal click region, such that the abnormal click region is automatically recognized, thereby improving accuracy and recognition efficiency.

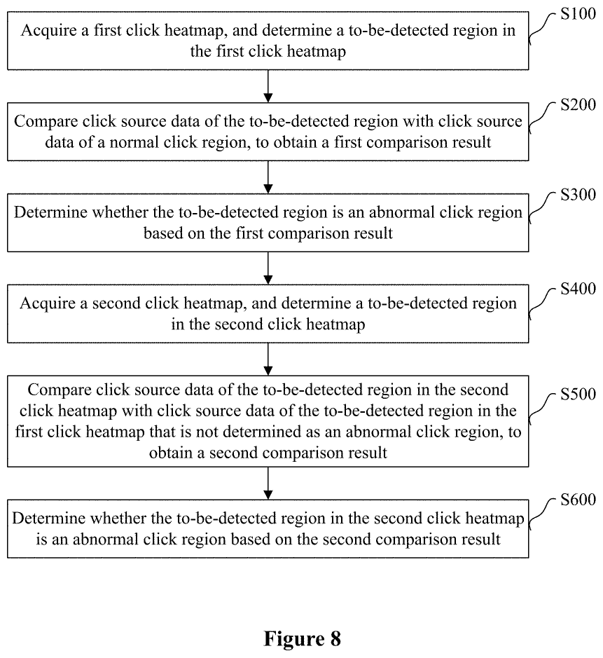

As shown in FIG. 8, based on the embodiment shown in FIG. 1, the method for detecting an abnormality in a click heatmap according to another embodiment of the present disclosure further includes the following steps S400 to S600.

In step S400, a second click heatmap is acquired, and a to-be-detected region in the second click heatmap is determined. The first click heatmap is obtained for a first page in a first time period. The second click heatmap is obtained for the first page in a second time period. The first time period is different from the second time period.

For a same page, click sources in different time periods (for example, two consecutive days) may be identical to each other. In this case, the click source data of the to-be-detected region in the click heatmap in the previous time period, which is not determined as the abnormal click region based on the first comparison result in the method shown in FIG. 1, may be used to compare with click source data of a to-be-detected region in the click heatmap in the later time period.

In step S500, click source data of the to-be-detected region in the second click heatmap is compared with click source data of the to-be-detected region that is not determined as an abnormal click region in the first click heatmap, to obtain a second comparison result.

In step S600, whether the to-be-detected region in the second click heatmap is an abnormal click region is determined based on the second comparison result.

In the steps S400 to S600 of the method shown in FIG. 8, the click source data of the to-be-detected region in the click heatmap in the previous time period, which is not determined as the abnormal click region based on the first comparison result by the method shown in FIG. 1, may be used to compare with click source data of a to-be-detected region in the click heatmap in the later time period, so as to simplify the process of determining the abnormal click region.

Corresponding to the above embodiments of the method, a device for detecting an abnormality in a click heatmap is further provided according to an embodiment of the present disclosure.

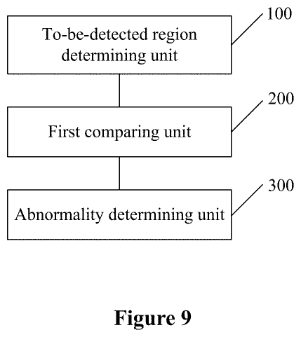

As shown in FIG. 9, the device for detecting an abnormality in a click heatmap according to the embodiment of the present disclosure may include a to-be-detected region determining unit 100, a first comparing unit 200, and an abnormality determining unit 300.

The to-be-detected region 100 determining unit is configured to acquire a first click heatmap and determine a to-be-detected region in the first click heatmap.

In the present disclosure, the first click heatmap may be acquired from other electronic devices. Alternatively, the first click heatmap may be generated based on click data from other electronic devices.

In the present disclosure, the click data may be normalized after being acquired, and then is transposed, divided into intervals, and filtered. Finally, a click heatmap is generated based on the filtered click data.

Optionally, the to-be-detected region determining unit 100 may include a dividing subunit and a segmenting subunit. The dividing subunit is configured to divide the first click heatmap into multiple sub-regions having a same area and a same shape. The segmenting subunit is configured to segment the first click heatmap which is divided into the multiple sub-regions by using an image segmentation algorithm, to obtain a to-be-detected region formed by several of the multiple complete sub-regions, where a click amount of each of the several of the multiple sub-regions in the to-be-detected region is greater than a first preset threshold.

The device shown in FIG. 9 may further include a normal click region determining unit, which is configured to determine a region other than the to-be-detected region in the first click heatmap as a normal click region.

The to-be-detected region in the first click heatmap may be a region having a larger click amount than other regions in the first click heatmap.

It is founded by the present disclosure that, click data generated from fake traffic is generally concentrated in some regions, resulting in large click amounts of these regions. Therefore, in the present disclosure, a region having a large click amount may be determined as the to-be-detected region. Accordingly, a region having a small click amount may be determined as a normal click region. It is also found that distributions of sources of click data of two different regions are similar to each other if the click data are generated by real users. For example, a webpage includes a first region and a second regain, and click data of the webpage are from three sources B, C and D. Proportions of the click data from the three sources to total click data of the first region are 10%, 20% and 70%, respectively. Proportions of the click data from the three sources to total click data of the second region are 8%, 23% and 69%, respectively.

The first comparing unit 200 is configured to compare click source data of the to-be-detected region with click source data of a normal click region, to obtain a first comparison result.

Optionally, the first comparing unit 200 is configured to compare the click source data by calculating a correlation coefficient between the click source data of the to-be-detected region and the click source data of the normal click region. The calculated correlation coefficient serves as the first comparison result.

The abnormality determining unit 300 is configured to determine whether the to-be-detected region is an abnormal click region based on the first comparison result.

The abnormality determining unit 300 may be configured to determine whether the correlation coefficient serving as the first comparison result is less than a second preset threshold, and determine that the to-be-detected region is an abnormal click region in a case that the correlation coefficient serving as the first comparison result is less than the second preset threshold.

Optionally, in a case that the correlation coefficient serving as the first comparison result is not less than the second preset threshold, the abnormality determining unit 300 may further be configured to determine the to-be-detected region as a normal click region.

In another embodiment of the present disclosure, the device as shown in FIG. 9 may further include a heatmap acquiring unit, a second comparing unit and an abnormal region determining unit.

The heatmap acquiring unit is configured to acquire a second click heatmap, and determine a to-be-detected region in the second click heatmap. The first click heatmap is obtained for a first page in a first time period. The second click heatmap is obtained for the first page in a second time period. The first time period is different from the second time period.

For a same page, click sources in different time periods (for example, two consecutive days) may be identical to each other. In this case, the click source data of the to-be-detected region in the click heatmap of the previous time period, which is not determined as the abnormal click region based on the first comparison result, may be used to compare with click source data of a to-be-detected region in the click heatmap of the later time period.

The second comparing unit is configured to compare click source data of the to-be-detected region in the second click heatmap with click source data of the to-be-detected region that is not determined as an abnormal click region in the first click heatmap, to obtain a second comparison result.

The abnormal region determining unit is configured to determine whether the to-be-detected region in the second click heatmap is an abnormal click region based on the second comparison result.

In this embodiment, the click source data of the to-be-detected region in the click heatmap in the previous time period, which is not determined as the abnormal click region based on the first comparison result with the device as shown in FIG. 9, may be compared with click source data of a to-be-detected region in the click heatmap in the later time period, so as to simplify the process of determining the abnormal click region.

In another embodiment of the present disclosure, the device as shown in FIG. 9 may further include a mark adding unit, which is configured to add a predetermined mark to the to-be-detected region that is determined as the abnormal click region.

By adding the predetermined mark, it is convenient for an advertisement buyer to find the abnormal click region determined according to the present disclosure.

Further, the first click heatmap in which the abnormal click region is added with the predetermined mark may cover an interface image corresponding to the first click heatmap. The interface image may be a webpage interface image, an application interface image, or the like. By covering the interface image, it is further convenient for a user to find a position of the abnormal click region in the interface image, for further analysis and use.

In the device for detecting an abnormality in a click heatmap according to the embodiment of the present disclosure, the to-be-detected region in the first click heatmap is determined. The click source data of the to-be-detected region is compared with the click source data of the normal click region, to obtain the first comparison result. Whether the to-be-detected region is an abnormal click region is determined based on the first comparison result. It is found from studies that, click source data of an abnormal click region is significantly different from the click source data of the normal click region. Therefore, whether the to-be-detected region is an abnormal click region can be determined based on a comparison result between the click source data of the to-be-detected region and the click source data of the normal click region, such that the abnormal click region is automatically recognized, thereby improving accuracy and recognition efficiency.

The device for detecting an abnormality in a click heatmap includes a processor and a memory. The to-be-detected region determining unit, the first comparing unit, and the abnormality determining unit and other units are stored in the memory as program units, which are executed by the processor to achieve their functions.

The processor includes a core configured to call the program unit from the memory. The number of the core may be one or more. Parameters of the core may be adjusted for the determination of abnormal click regions.

The memory may be implemented by computer readable medium of a non-persistent memory, a random-access memory (RAM), and/or a non-volatile memory, such as a read only memory (ROM) or a flash RAM. The memory includes at least one memory chip.

A storage medium is provided according to an embodiment of the present disclosure. The storage medium includes programs. The programs, when being executed by a processor, perform the method for detecting an abnormality in a click heatmap.

A processor is provided according to an embodiment of the present disclosure. The processor is configured to execute programs to perform the method for detecting an abnormality in a click heatmap.

A device is provided according to an embodiment of the present disclosure. The device includes a processor, a memory and programs stored in the memory, where the programs are executable by the processor. The processor executes the programs to perform the following steps of: acquiring a first click heatmap, and determining a to-be-detected region in the first click heatmap; comparing click source data of the to-be-detected region with click source data of a normal click region, to obtain a first comparison result; and determining whether the to-be-detected region is an abnormal click region based on the first comparison result.

Optionally, the determining a to-be-detected region in the first click heatmap includes: dividing the first click heatmap into multiple sub-regions having a same area and a same shape; and segmenting the first click heatmap which is divided into the multiple sub-regions by using an image segmentation algorithm, to obtain a to-be-detected region formed by several of the multiple complete sub-regions, where a click amount of each of the several of the multiple sub-regions in the to-be-detected region is greater than a first preset threshold.

The processor may execute the programs to further perform the following step of: determining a region other than the to-be-detected region in the first click heatmap as the normal click region.

Optionally, the processor may execute the programs to further perform the following steps of: acquiring a second click heatmap, and determining a to-be-detected region in the second click heatmap, where the first click heatmap is obtained for a first page in a first time period, the second click heatmap is obtained for the first page in a second time period, and the first time period is different from the second time period; comparing click source data of the to-be-detected region in the second click heatmap with click source data of the to-be-detected region that is not determined as an abnormal click region in the first click heatmap, to obtain a second comparison result; and determining whether the to-be-detected region in the second click heatmap is an abnormal click region based on the second comparison result.

Optionally, the comparing click source data of the to-be-detected region with click source data of a normal click region, to obtain a first comparison result includes: calculating a correlation coefficient between the click source data of the to-be-detected region and the click source data of the normal click region, where the calculated correlation coefficient serves as the first comparison result.

Optionally, the determining whether the to-be-detected region is an abnormal click region based on the first comparison result includes: determining whether the correlation coefficient serving as the first comparison result is less than a second preset threshold, and determining that the to-be-detected region is an abnormal click region in a case that the correlation coefficient serving as the first comparison result is less than the second preset threshold.

Optionally, the processor may execute the programs to further perform the following step of: adding a predetermined mark to the to-be-detected region that is determined as the abnormal click region.

The device in the present disclosure may be a server, a PC, a PAD, a cellphone or the like.

A computer program product is further provided in the present disclosure. The computer program product is applicable to, when being executed on a data processing device, execute programs initialized with the following steps of: acquiring a first click heatmap, and determining a to-be-detected region in the first click heatmap; comparing click source data of the to-be-detected region with click source data of a normal click region, to obtain a first comparison result; and determining whether the to-be-detected region is an abnormal click region based on the first comparison result.

Optionally, the determining a to-be-detected region in the first click heatmap includes: dividing the first click heatmap into multiple sub-regions having a same area and a same shape; and segmenting the first click heatmap which is divided into the multiple sub-regions by using an image segmentation algorithm, to obtain a to-be-detected region formed by several of the multiple complete sub-regions, where a click amount of each of the several of the multiple sub-regions in the to-be-detected region is greater than a first preset threshold.

The computer program product may be further applicable to, when being executed on the data processing device, execute programs initialized with the following step of: determining a region other than the to-be-detected region in the first click heatmap as the normal click region.

Optionally, the computer program product may be further configured to, when being executed on the data processing device, execute programs initialized with the following steps of: acquiring a second click heatmap, and determining a to-be-detected region in the second click heatmap, where the first click heatmap is obtained for a first page in a first time period, the second click heatmap is obtained for the first page in a second time period, and the first time period is different from the second time period; comparing click source data of the to-be-detected region in the second click heatmap with click source data of the to-be-detected region that is not determined as an abnormal click region in the first click heatmap, to obtain a second comparison result; and determining whether the to-be-detected region in the second click heatmap is an abnormal click region based on the second comparison result.

Optionally, the comparing click source data of the to-be-detected region with click source data of a normal click region, to obtain a first comparison result includes: calculating a correlation coefficient between the click source data of the to-be-detected region and the click source data of the normal click region, where the calculated correlation coefficient serves as the first comparison result.

Optionally, the determining whether the to-be-detected region is an abnormal click region based on the first comparison result includes: determining whether the correlation coefficient serving as the first comparison result is less than a second preset threshold, and determining that the to-be-detected region is an abnormal click region in a case that the correlation coefficient serving as the first comparison result is less than the second preset threshold.

Optionally, the computer program product may be further configured to, when being executed on the data processing device, execute programs initialized with the following step of adding a predetermined mark to the to-be-detected region that is determined as the abnormal click region.

It should be understood by those skilled in the art that the embodiments of the present disclosure may be implemented as methods, devices or computer program products. Therefore, the present disclosure may be implemented by embodiments of only hardware, only software, or a combination of hardware and software. The present disclosure may be implemented as computer program products on one or more computer storage mediums (including but not limited to a magnetic disk memory, CD-ROM and an optical memory or the like) including computer-readable program codes.

The present disclosure is described with reference to flowcharts and/or block diagrams of the methods, devices (systems) and computer program products according to the embodiments. It should be understood that, each flow or a combination of flows in the flowcharts and/or each block or a combination of blocks in the block diagrams may be implemented by computer program instructions. The computer program instructions may be provided to a general-purpose computer, a dedicated computer, an embedded processor or processors of other programmable data processing devices to generate a machine, so that the instructions executed by the computer or the processors of the other programmable data processing devices generate a device for implementing functions specified in one or more flows of the flowcharts and/or one or more blocks of the block diagrams.

The computer program instructions may also be stored in a computer readable memory which can guide the computer or other programmable data processing devices to operate in a certain manner, so that the instructions stored in the computer readable memory generate a product including an instruction device which implements functions specified in one or more flows of the flowcharts and/or one or more blocks of the block diagrams.

The computer program instructions may also be loaded to the computer or other programmable data processing devices, so that the computer or other programmable devices perform a series of operation steps to generate processing implemented by the computer, and thus the instructions executed on the computer or other programmable devices provide steps for implementing the functions specified in one or more flows of the flowcharts and/or one or more blocks of the block diagrams.

In a typical configuration, a computing device includes one or more central processing units (CPU), input/output interfaces, network interfaces and memories.

The memory may be implemented by a non-persistent memory, a random-access memory (RAM), and/or a non-volatile memory in a computer readable medium, such as a read only memory (ROM) or a flash RAM. The memory includes at least one memory chip.

The computer readable medium may include a persistent and non-persistent, and removable and non-removable medium. Information may be stored by any methods or technologies. The information may be computer readable instructions, data structures, program modules or other data. The storage medium of the computer may include but is not limited to a phase change random-access memory (PRAM), a static random-access memory (SRAM), a dynamic random-access memory (DRAM), other types of random-access memory (RAM), read-only memory (ROM), electrically erasable programmable read-only memory (EEPROM), flash memory or other memory, compact disk read-only memory (CD-ROM), digital Versatile disc (DVD), or other optical storage, cassette tape, tape disk memory or other magnetic storage, or any non-transmission medium which can be used to store information accessible by the computer. As defined in the present disclosure, the computer readable medium does not include transitory computer-readable media, such as a modulated data signal and carrier wave.

It should be further noted that terms of “include”, “comprise” or any other variants in the embodiments of the present disclosure are intended to be non-exclusive. Therefore, a process, method, product or device including a series of elements includes not only the elements but also other elements that are not enumerated, or also include the elements inherent to the process, method, product or device. Unless expressively limited otherwise, the statement “comprising (including) a . . . ” does not exclude the case that other similar elements may exist in the process, method, product or device.

It should be understood by those skilled in the art that the embodiments of the present disclosure may be implemented as methods, devices or computer program products. Therefore, the present disclosure may be implemented by embodiments of only hardware, only software, or a combination of hardware and software. The present disclosure may be implemented as computer program products on one or more computer storage mediums (including but not limited to a magnetic disk memory, CD-ROM and an optical memory or the like) including computer-readable program codes.

The foregoing is merely some embodiments of the present disclosure and are not intended to limit the present disclosure, and those skilled in the art can make various modifications and variations to the present disclosure. Any modifications, equivalent substitutions and improvements made within the spirit and the principle of the present disclosure are within the scope of claims of the present disclosure.

1. A method for detecting an abnormality in a click heatmap, comprising:
acquiring a first click heatmap, and determining a to-be-detected region in the first click heatmap;
comparing click source data of the to-be-detected region with click source data of a normal click region, to obtain a first comparison result; and
determining whether the to-be-detected region is an abnormal click region based on the first comparison result.

2. The method according to claim 1, wherein
the determining a to-be-detected region in the first click heatmap comprises:
dividing the first click heatmap into a plurality of sub-regions having a same area and a same shape; and
segmenting the first click heatmap which is divided into the plurality of sub-regions by using an image segmentation algorithm, to obtain a to-be-detected region formed by several of the plurality of sub-regions, wherein a click amount of each of the several of the plurality of sub-regions in the to-be-detected region is greater than a first preset threshold; and
the method further comprises: determining a region other than the to-be-detected region in the first click heatmap as the normal click region.

3. The method according to claim 1, further comprising:
acquiring a second click heatmap, and determining a to-be-detected region in the second click heatmap, wherein the first click heatmap is obtained for a first page in a first time period, the second click heatmap is obtained for the first page in a second time period, and the first time period is different from the second time period;
comparing the click source data of the to-be-detected region in the second click heatmap with the click source data of the to-be-detected region that is not determined as an abnormal click region in the first click heatmap, to obtain a second comparison result; and
determining whether the to-be-detected region in the second click heatmap is an abnormal click region based on the second comparison result.

4. The method according to claim 1, wherein the comparing the click source data of the to-be-detected region with the click source data of a normal click region, to obtain a first comparison result comprises:
calculating a correlation coefficient between the click source data of the to-be-detected region and the click source data of the normal click region, wherein the calculated correlation coefficient serves as the first comparison result.

5. The method according to claim 4, wherein the determining whether the to-be-detected region is an abnormal click region based on the first comparison result comprises:
determining whether the correlation coefficient serving as the first comparison result is less than a second preset threshold, and determining that the to-be-detected region is an abnormal click region in a case that the correlation coefficient serving as the first comparison result is less than the second preset threshold.

6. The method according to claim 1, further comprising:
adding a predetermined mark to the to-be-detected region that is determined as the abnormal click region.

7. A device for detecting an abnormality in a click heatmap, comprising:
a to-be-detected region determining unit configured to acquire a first click heatmap and determine a to-be-detected region in the first click heatmap;
a first comparing unit configured to compare click source data of the to-be-detected region with click source data of a normal click region, to obtain a first comparison result; and
an abnormality determining unit configured to determine whether the to-be-detected region is an abnormal click region based on the first comparison result.

8. The device according to claim 7, wherein
the to-be-detected region determining unit comprises:
a dividing subunit configured to divide the first click heatmap into a plurality of sub-regions having a same area and a same shape; and
a segmenting subunit configured to segment the first click heatmap which is divided into the plurality of sub-regions by using an image segmentation algorithm, to obtain a to-be-detected region formed by several of the plurality of sub-regions, wherein a click amount of each of the several of the plurality of sub-regions in the to-be-detected region is greater than a first preset threshold; and
the device further comprises a normal click region determining unit configured to determine a region other than the to-be-detected region in the first click heatmap as the normal click region.

9. A storage medium comprising programs, wherein the programs,
when being executed, control a device in which the storage medium is located to perform the method for detecting an abnormality in a click heatmap according to claim 1.

10. A processor configured to execute programs to perform the method for detecting an abnormality in a click heatmap according to claim 1.

11. The method according to claim 2, further comprising:
acquiring a second click heatmap, and determining a to-be-detected region in the second click heatmap, wherein the first click heatmap is obtained for a first page in a first time period, the second click heatmap is obtained for the first page in a second time period, and the first time period is different from the second time period;
comparing the click source data of the to-be-detected region in the second click heatmap with the click source data of the to-be-detected region that is not determined as an abnormal click region in the first click heatmap, to obtain a second comparison result; and
determining whether the to-be-detected region in the second click heatmap is an abnormal click region based on the second comparison result.

12. The method according to claim 2, further comprising:
adding a predetermined mark to the to-be-detected region that is determined as the abnormal click region.

13. The method according to claim 3, further comprising:
adding a predetermined mark to the to-be-detected region that is determined as the abnormal click region.
